(19) United States
(12) Patent Application Publication
(10) Pub. No.: US 2026/0100825 A1
(43) Pub. Date: Apr. 9, 2026

(54) Method and system for standard-compliant, confidential receipt of data for encrypted data processing

(71) Applicant: Bergische Universität Wuppertal, Körperschaft des öffentlichen Rechts, Wuppertal (DE)

(72) Inventors: Amin FAEZ, Remscheid (DE); Tibor JAGER, Velbert (DE); David NIEHUES, Paderborn (DE)

(21) Appl. No.: 19/351,496

(22) Filed: Oct. 7, 2025

(30) Foreign Application Priority Data
Oct. 7, 2024 (DE) 102024128803.5

(51) Int. Cl. H04L 9/08; H04L 9/06; H04L 9/32

(52) U.S. Cl. CPC H04L 9/085; H04L 9/0637; H04L 9/3242

(57) ABSTRACT

A method for standard-compliant, confidential receipt of data is set forth. The method is executable via a system for data processing, in particular a system for standard-compliant, confidential receipt of data. The data is divided into secret shares already upon receipt, so that none of the servers involved can see the received data in plain text and the method thus enables encrypted data processing and secure data receipt.

### CROSS REFERENCE TO RELATED APPLICATIONS

This application claims priority to German Application No. DE102024128803.5 filed on Oct. 7, 2024, the entire contents of which are incorporated herein by reference.

### TECHNICAL FIELD

This disclosure relates to the technical field of encrypted data processing. More specifically, the disclosure relates to a method and a system for standard-compliant, confidential receipt of data, which enables encrypted data processing.

### BACKGROUND

In the modern digital world, the protection of sensitive information is of utmost importance. Encryption methods are essential tools for ensuring the confidentiality and integrity of data. These methods transform readable data (plain text) into an unreadable form (cipher text), which can only be converted back into plain text by authorized recipients using a key. The development and application of such encryption methods are therefore of central interest for a wide range of applications, including communication, storage and transmission of data.

Symmetric encryption methods use the same key for encrypting and decrypting data. A prominent example of this is the Advanced Encryption Standard (AES). Symmetric methods are generally very efficient and are particularly suitable for encrypting large amounts of data. The main prerequisite for their security is the secure exchange of the secret key between the communication partners.

Hybrid encryption methods combine the advantages of symmetric and asymmetric methods. Typically, a symmetric key is securely exchanged using an asymmetric method and then used to encrypt the actual message. These hybrid methods offer both the efficiency of symmetric encryption and the security advantages of asymmetric encryption.

Block ciphers such as AES can be used in different operating modes to meet different security requirements. Common modes include:

ECB (Electronic Codebook Mode): A simple but, in many applications, insecure mode in which each data block is encrypted independently.

CBC (Cipher Block Chaining Mode): Each block is linked to the previous cipher block before encryption, which prevents pattern formation in the cipher text.

CTR (Counter Mode): Converts the block cipher into a stream cipher by encrypting a counter and combining it with the plain text using XOR. This mode allows parallel processing.

The selection of the appropriate encryption method depends on various factors, including the type of data to be protected, performance requirements and the specific security requirements. Symmetric methods offer high efficiency, while asymmetric methods offer the advantage of secure key exchange. Hybrid methods combine these advantages and offer a flexible solution for most applications. Security can be further customized and optimized through the use of operating modes.

To describe the underlying technical problem of the known encryption methods, let us first consider the example of a secure email provider that promises its customers to store all emails in encrypted form only, without having access to the plain text itself. This offers very strong protection for the confidentiality of emails, which is maintained even if the email provider's computer systems are compromised by an attacker. However, existing technologies cannot guarantee that the email provider will never have access to the emails. The reason for this is that an email provider has no influence over whether and how the emails it receives for its customers from third-party providers are also encrypted by the respective sender (for example, with PGP or S/MIME encryption). In fact, emails are usually sent in plain text. As a result, the email provider can read all plain-text emails it receives for its customers at the moment of receipt. In order to achieve the promised encrypted storage, the email is encrypted immediately after receipt so that only the recipient can decrypt it. However, this current state of the art has the following significant disadvantages:

1. Although encrypted storage of emails is achieved, the email provider still has access to the plain-text emails received, at least for a short time. The confidentiality of the received data cannot therefore be guaranteed.

2. If the provider's computer systems are compromised, an attacker could also gain full access to the plain text of the emails received and thus bypass the encryption.

3. Encrypted storage prevents the provider from processing plain-text emails on the server side, for example to enable search functions or automated content classification using AI.

The provider could develop and implement a new, proprietary email process in which emails are always encrypted by the sender. However, this new development would be incompatible with the existing email infrastructure. Since email is a widely used, standardized process throughout the internet, such proprietary processes do not seem realistic to implement. Finding a solution that is both standard-compliant and ensures that emails are never stored in plain text on a single provider system seems unachievable with conventional techniques.

Confidential emails are just one of many examples of applications where such a problem occurs. Other examples are:

Reliable benchmarking: Various companies supply confidential key data to a central service provider. This processes the key data confidentially and uses it to calculate statistics that enable participating companies to perform reliable benchmarking. This benchmarking allows the identification of potential for efficiency gains or cost savings. This gives rise to three major challenges, which correspond to the three disadvantages mentioned above: 1. When benchmarking confidential key data, the service provider should not have access to the confidential data. 2. In the event of a compromise, an attacker should not be granted access. 3. When using conventional encryption, it is impossible for the service provider to process data and thus calculate statistics.

Confidential machine data: Various operators of production machines collect machine data. This data is confidential because it allows conclusions to be drawn about production processes and thus trade secrets. This data is transmitted to a central service provider, who processes it confidentially. This data is used, for example, to predict maintenance requirements (predictive maintenance), identify potential for optimization in machine operation, or collect and compare key performance indicators such as downtime and maintenance intensity in order to identify potential for improvement.

The challenges arising here are: 1. When processing confidential machine data that could allow conclusions to be drawn about secret production processes, the service provider should not have access to the confidential data either. 2. In the event of a compromise, an attacker should not be granted access. 3. When using conventional encryption, joint processing of the data by the service provider becomes impossible.

Medical data: Confidential medical patient data is highly sensitive and should therefore be stored in encrypted form throughout (i.e., end-to-end). At the same time, it would be helpful for medical research and the development of therapies, detection of side effects, etc., to be able to carry out evaluations on a large number of people. This could be achieved by storing the data jointly at a shared service provider.

The challenges arising here are: 1. When processing confidential patient data, the service provider should not have access to the confidential data either. 2. In the event of a compromise, an attacker should not be granted access. 3. When using conventional encryption, joint processing of the data by the service provider becomes impossible.

Data spaces and data trustees: In the course of digitalization, data spaces and data trustees are being discussed and implemented. One example of this is the Mobility Data Space (https://bmdv.bund.de/DE/Themen/Digitales/Mobility-Data-Space/mds.html). The idea behind shared data spaces is to give data to a data trustee for joint processing, who can then process it centrally.

The challenges arising here are: 1. The data trustee has full access to all data, so all participants must trust them completely. They also represent a single point of failure. When processing confidential data, the trustee should not have access to the confidential data either. 2. In the event of a compromise, an attacker should not be granted access. 3. When using conventional encryption, joint processing of the data by the trustee becomes impossible.

Secure file storage with server-side functionality: Secure file storage in cloud storage can be achieved, for example, by encryption with special tools. However, encryption makes it impossible for the cloud provider to enable server-side functions such as search or filter functions, automatic document classification, spell checking, processing with large language models such as ChatGPT, or access via a web interface. These functions can only be achieved with unencrypted file storage.

The challenges arising here are: 1. The cloud provider has full access to all files, so all users must trust the cloud provider completely. When processing confidential data, the cloud provider should not have access to the confidential data, or this may even be prohibited by legal frameworks or contracts with business partners. 2. In the event of a compromise of the cloud provider, an attacker should not be able to access the files. 3. When using conventional encryption, it becomes impossible for the cloud provider to process the files.

Evaluation of AI models on confidential data: An AI provider offers the use of an extensively trained AI model for classifying confidential data.

The challenges arising here are: 1. If the AI provider is given full access to the data to be classified, then customers must trust the AI provider completely. When processing confidential data, the AI provider should not have access to the confidential data either. At the same time, the AI provider cannot share its extensively trained AI model with customers, as this model represents its business advantage. 2. In the event of a compromise of the AI provider or the customer, an attacker should not be able to access the data or the model. 3. When using conventional encryption, joint processing of the data by the AI provider becomes impossible.

There are, in essence, three different approaches to addressing the disadvantages and challenges described above:

1. Acceptance of the disadvantages. The problem is considered impractical to solve and the disadvantages are accepted. Most solutions in practice are still based on this approach. Either the risk is accepted, and data is shared with third parties. In such cases, the usefulness of the data outweighs its protection. Or, sharing confidential data with other companies or an external service provider is considered unacceptable, or is excluded by legal requirements (e.g., data protection, labor law, antitrust law), or prevented by confidentiality agreements with customers and business partners. In this case, data protection outweighs usability, and potential efficiency and optimization gains are also foregone.

2. Trusted Execution Environments. Trusted Execution Environments (TEEs), such as Intel's SGX (Software Guard Extensions) technology. These constitute a security functionality (secure enclaves) that is integrated into modern CPUs and is intended to enable secure execution, where even the operating system of the processing system cannot access confidential data. Such techniques offer many advantages over processing of data in plain text. However, there are also a long list of vulnerabilities and attacks, such as Foreshadow, CacheOut, SGAxe, Plundervolt and Load Value Injection, which have shown that such secure enclaves are difficult to implement securely.

3. Oblivious TLS (https://eprint.iacr.org/2021/318): This is an implementation of the TLS protocol using cryptographic secure multi-party computation (MPC) techniques. In principle, this approach makes it possible to overcome all of the disadvantages and challenges described above. Since the entire TLS protocol is implemented in MPC technology, it requires orders of magnitude more hardware resources and runtime than conventional TLS implementations. Therefore, practical use of this technology is currently conceivable at best in niche applications.

### SUMMARY

One problem addressed by the present description, per an embodiment, is to provide a method and a system for standard-compliant, confidential receipt of data for encrypted data processing, wherein the method can offer a significant performance gain over the methods known from the prior art.

According to an embodiment, the problem is solved by a computer-implemented method for standard-compliant, confidential receipt of data, wherein the method is executable by way of a system for data processing, in particular a system for standard-compliant, confidential receipt of data, the system comprising:
at least one client (C), wherein the client (C) is set up to send data,
at least one server (S), wherein the server (S) has implemented a cryptographic protocol for encrypting data and is set up to receive data from the client (C),
at least one proxy server (P) located on a communication path (K) between the client (C) and the server (S), wherein communication between the client (C) and the server (S) runs partially or completely via the proxy server (P),
   the method comprising the following steps:
A. Exchanging data for calculating a shared key k between the client (C) and the server (S), wherein the server (S) derives at least one key k_{Enc} from the key k, wherein preferably k_{Enc} is identical to k or is calculated from k, preferably using a key derivation function or a hash function,
B. Sending data from the client (C) to the server (S), wherein the data is encrypted using an operating mode in which block ciphers are operated for a symmetric encryption application, wherein the i-th message tᵢ from the client (C) to the server (S) contains an encryption Mᵢ⊕Kᵢ, wherein Mᵢ is the plain-text data of the i-th message and Kᵢ is the key of the operating mode, which is derived from k_{Enc} and the value tᵢ is the cryptographic value of the message,
C. Receiving the data by the proxy server (P) and processing the value tᵢ in accordance with the cryptographic protocol, wherein tᵢ is the cryptographic value of the message,
D. Selecting a random string Rᵢ by the proxy server (P), wherein the length of the random string Rᵢ corresponds to the length of Mᵢ⊕Kᵢ,
E. Forwarding Mᵢ⊕Kᵢ⊕Rᵢ to the server (S) through the proxy server (P) and storing the random string Rᵢ by the proxy server (P),
F. Receiving Mᵢ⊕Kᵢ⊕Rᵢ by the server (S) and calculating the value Mᵢ⊕Rᵢ using the key Kᵢ, wherein Rᵢ⊕(Mᵢ⊕Rᵢ)=Mᵢ applies, whereby the proxy server (P) and the server (S) each obtain an additive ⊕ secret sharing of the data Mᵢ,
   wherein the method for sending a message

$${M}_{j}^{′}$$

comprises the following steps:
G. Calculating an encryption of a secret share

$$( {R}_{j}^{′} ⊕ {M}_{j}^{′} )$$

⊕Kⱼ by means of the server (S), wherein Kⱼ is derived from k_{Enc} and

$$( {R}_{j}^{′} ⊕ {M}_{j}^{′} )$$

is the secret share of

$${M}_{j}^{′}$$

held by the server (S),
H. Sending the encryption to the proxy server (P) via the server (S), calculating a

$${M}_{j}^{′} ⊕ {K}_{j}$$

via the proxy server (P) by applying a share

$${R}_{j}^{′} .$$

The present disclosure, per an embodiment, relates to a method for standard-compliant, confidential receipt of data, wherein the method is executable by way of a system for data processing, in particular a system for standard-compliant, confidential receipt of data. The basic idea of the present disclosure, per an embodiment, is to divide the data into secret shares already upon receipt, so that none of the servers involved ever sees the received data in plain text and the method thus enables encrypted data processing and secure data receipt. The method divides a single server that receives the confidential data into at least two servers, P and S, so that P and S each receive a cryptographic secret share of the received data. Secret sharing guarantees that no single server receives information about the data received; from the perspective of each individual server, the data is purely random. Distributing the data across multiple servers prevents a single compromised server from accessing all confidential data. Even if one server is compromised, an attacker cannot access the complete data, as only part of the data (one secret share) is available. Since the complete data is not stored in a single location, the attack area is reduced. Attackers would have to compromise both servers to access the entire data, which significantly increases the security barrier. Secret sharing ensures that the data is divided into parts and made unreadable during transmission and storage. Only by combining the corresponding shares can the original data be reconstructed, which protects confidentiality. In contrast to the previous state of the art, this method enables the secure receipt of data in such a way that this data is already divided into secret shares upon receipt, so that none of the servers involved ever sees the received data in plain text. The method is only marginally less efficient than, for example, a standard TLS implementation, as the proxy server P merely forwards data packets or applies a simple binary XOR operation to them, which can be implemented extremely efficiently. At the same time, secret sharing provides the basis for the application of modem cryptographic secure multi-party computation techniques, which enable joint processing of the data by P and S without any single server ever seeing the complete data. An attacker who wants to obtain the received data must compromise P and S simultaneously. P and S could be implemented on different operating systems, so that the probability of a simultaneous security breach is very low. In various embodiments, there are different methods for securely exchanging the symmetric key k between the client and the server. One possibility is for the key to be entered manually by a trusted person on both computers, which requires that the person keep and transfer the key securely. Another method is to exchange the key via encrypted email, wherein both parties must already have secure email encryption such as PGP or S/MIME. Similarly, the key can be stored in an encrypted file archive, for example using Zip with AES encryption, in a cloud storage service so that both parties can download and decrypt the key. In addition, secure file exchange services such as SecureDrop or OnionShare, which operate via the Tor network, can be used to transfer the key securely. Another option is to transmit the key in parts via a secure phone call, with one part of the key being transmitted via a call and the other part via another secure method to increase security. The key can also be converted into a QR code and then exchanged between the parties using a secure, physically scanned medium. Alternatively, the key can be loaded onto a smart card or hardware security module (HSM), which is then physically transported to the systems involved and used there. Transfer via NFC (Near Field Communication) or Bluetooth is also possible, provided that both devices are in close proximity and the transfer is encrypted. Another option is to exchange the key via a secure transport protocol such as TLS or IPSec, wherein a secure connection is first established and the key is then transferred via this connection. Instead of directly exchanging the key k, both parties can derive the key k from a shared secret and additional parameters, such as nonces. A public key infrastructure (PKI) can also be used, whereby one party encrypts the symmetric key with the other party's public key and sends it, so that the recipient can decrypt the key with their private key.

In a technically advantageous embodiment, step D is omitted and the proxy server (P) merely sends the length [symbol] of Mᵢ⊕Kᵢ to the server (S), wherein the proxy server (P) uses Mᵢ⊕Kᵢ as its secret share, and the server (S) uses Kᵢ as its secret share. The proxy server (P) then uses Mᵢ⊕Kᵢ as the secret share of Mᵢ in calculations, and the server (S) uses the first [symbol] bits of Kᵢ as the secret share of Mᵢ in calculations. Since Mᵢ⊕Kᵢ⊕Kᵢ=Mᵢ still applies, the proxy server (P) and the server (S) still possess correct secret shares. This embodiment has the advantage that the proxy server (P) only has to send [symbol] to the server (S) and the effort of randomly selecting Rᵢ is eliminated.

In one embodiment, a MAC is also calculated. For this purpose, the server (S) derives a key k_{MAC} from k by either using k directly as k_{MAC} or derives k_{MAC} using a key derivation function or hash function. In various embodiments, the proxy server (P) receives k_{MAC} from the server (S) in order to calculate or verify the MAC. However, it is also possible for the client and server to interactively calculate a correct MAC together. For this, it is not necessary for the proxy to receive k_{MAC}. The secret shares held by the server (S) and proxy server (P) are sufficient for this purpose. The canonical verification of MACs (message authentication codes) consists of the recipient using the same MAC calculation function as the sender, using the same secret key and the same message to generate a MAC. This newly calculated MAC is then compared with the received MAC. If both MACs match, the message is considered authentic and unaltered, as only the legitimate sender and recipient know the secret key and are able to calculate the correct MAC. This verification method ensures that the integrity and authenticity of the message are preserved.

In a further technically advantageous embodiment, the exchange of data for calculating a shared key k between the client (C) and the server (S) comprises starting a communication session between the client (C) and the server (S), wherein the cryptographic protocol for exchanging k comprises at least one of the following protocols: OPC Unified Architecture OPCUA, Secure Shell SSH, Wireguard, Transport Layer Security TLS and/or Internet Protocol Security IPSec. All protocols (OPCUA, SSH, Wireguard, TLS and IPSec) have in common that communication can be roughly divided into two phases: A key exchange phase and a communication phase. The method can be applied equally to each of these protocols. During the key exchange phase, the proxy only forwards the communication and only becomes active during the communication phase. In the key exchange phase of all these protocols, the client (C) and the proxy server (P) have then derived a common key k. The proxy server (P) does not learn the key k, even if it can read all communication between the client (C) and the server (S). Nevertheless, during the communication phase described above, the proxy server (P) can intervene in the communication in such a way that the proxy server (P) and the server (S) receive only secret shares of the plain-text messages Mᵢ. This allows the proxy server (P) and the server (S) to communicate with the client (C) in such a way that it appears to the client (C) as if it were communicating with a normal server in accordance with one of the aforementioned protocols (OPCUA, SSH, Wireguard, TLS and IPSec), while at the same time the proxy server (P) and the server (S) only receive secret shares of the communicated data. In this case, the messages

$${{M}_{j}}^{′}$$

calculated in step G using secure multi-party computation correspond to the plain text of messages of the respective protocol (OPCUA, SSH, Wireguard, TLS or IPSec) in the communication phase of the respective protocol. Since the proxy server (P) and the server (S) only calculate secret shares of these messages, they do not learn anything about the contents of the plain-text messages.

The OPC Unified Architecture (OPC UA) is a communication protocol that was developed specifically for industrial automation systems. It provides a platform-independent interface that enables both reliable communication and data exchange between different devices and systems. One advantage of OPC UA is its ability to integrate and standardize different types of data, which significantly improves the interoperability and scalability of automation solutions. OPC UA also offers robust security mechanisms, including encryption and authentication, to ensure the integrity and confidentiality of the transmitted data. Secure Shell (SSH) is a network protocol primarily used for secure remote access to network devices and servers. It provides an encrypted connection that ensures both the confidentiality and integrity of the transmitted data. One advantage of SSH is that it provides a secure method for managing servers over insecure networks, such as the Internet. By using strong authentication mechanisms, such as public key authentication, SSH increases security and prevents unauthorized access. WireGuard is a modern VPN protocol known for its simplicity and performance. Compared to traditional VPN protocols, WireGuard features a lean code base and simple configuration, resulting in improved security and easier management. One advantage of WireGuard is its high speed and efficiency, which is achieved through modern cryptography techniques. This makes it particularly suitable for use in resource-constrained environments and mobile devices. Transport Layer Security (TLS) is a widely used security protocol used to encrypt data transmissions on the Internet. It ensures that communication between web browsers and servers remains confidential and protected from manipulation. TLS offers several security features, including data encryption, integrity protection and authentication, which collectively improve the security of online transactions and confidential data. One advantage of TLS is its ability to provide a secure communication layer over existing Internet protocols, making it versatile and widely used. Transport Layer Security (TLS) provides a comprehensive solution for securing communication over networks. Advantages include confidentiality through strong encryption, data integrity through MACs and hash functions, authentication through digital certificates, and protection against various types of attacks. In addition, TLS offers flexibility, interoperability, efficient session management, and advanced security features such as perfect forward secrecy. Internet Protocol Security (IPSec) is a protocol suite used to secure Internet Protocol communications by authenticating and encrypting each IP packet within a communication session. IPSec is particularly useful for setting up virtual private networks (VPNs) and offers comprehensive protection through encryption and authentication at the network layer. One advantage of IPSec is its ability to integrate security-related functions directly into the IP layer, providing seamless and transparent security for all applications and services on the network.

In a technically advantageous embodiment, the method comprises a cryptographic message authentication code MAC to achieve authenticity and integrity, wherein the cryptographic key k_{MAC} is a MAC key k_{MAC} and the server (S) derives the MAC key k_{MAC} from the key k and makes it available to the proxy server (P). A MAC enables the recipient to ensure that the received data has not been altered. Any change to the message, even if it only affects one bit, results in a different MAC, making it easy to detect manipulation. A MAC ensures that the message actually originates from the specified sender. Since the MAC is calculated using a secret key, only someone who knows this key can generate the correct MAC. This prevents an attacker from forging messages and posing as a legitimate sender. The MAC key derived in this process is a secret key shared by both the sender and the recipient and is used to calculate and verify the MAC. This key is a crucial part of the MAC method and plays a central role in ensuring the security and integrity of the data. It is advantageous, per an embodiment, if the Message Authentication Code MAC calculated in operating mode is checked using the cryptographic Secure Multi-party Computation MPC method. The use of MPC ensures that the calculation and checking of the MAC is tamper-proof. No single participant can influence the result of the check without being noticed. MPC protocols are devised to deliver correct results even in the event of malicious behavior by some participants. This ensures that the MAC check is reliable. Furthermore, it is advantageous, per an embodiment, if the calculation and verification of the MAC is performed using secure multi-party computation and the key k_{MAC} is not made available to the proxy server (P).

In a technically advantageous embodiment, the proxy server (P) uses the key k_{MAC} to calculate the required message authentication code MAC according to at least one of the following protocols: OPC Unified Architecture OPCUA, Secure Shell SSH, Wireguard, Transport Layer Security TLS and/or Internet Protocol Security IPSec, in order to obtain the cipher text to be sent to the client (C).

In a further technically advantageous embodiment, the method comprises a counter mode (CTR), a Galois counter mode (GCM) and/or a ChaCha20-Poly1305 as operating modes. The operating modes Counter Mode (CTR), Galois/Counter Mode (GCM), and the algorithm ChaCha20-Poly1305 each offer specific advantages in terms of security, efficiency and areas of application. Counter Mode (CTR) is an operating mode for block ciphers that converts the block cipher into a stream cipher. Since each block can be encrypted independently of the other blocks, CTR mode is ideal for parallel processing. This results in higher encryption and decryption speeds. CTR is relatively easy to implement because there is no dependency between blocks. Each block is generated by encrypting an incremented counter. It allows direct access to any data block without the need to decrypt the preceding blocks. This can be particularly useful for applications that require frequent access to specific data blocks. Errors in a cipher block only affect the corresponding plain-text block and not the entire data transmission.

Galois/Counter Mode (GCM) combines Counter Mode with an authentication function to ensure both confidentiality and integrity of the data. This can offer the following advantages. Integrated authentication: GCM offers Authenticated Encryption with Associated Data (AEAD), which means that both the integrity and confidentiality of the data are ensured. This protects against manipulation and unauthorized access. GCM is very efficient and can be parallelized for both encryption and authentication. This makes it ideal for high-speed applications. By using Galois Field multiplication for authentication, GCM offers strong security against various attacks. GCM is specially optimized for hardware implementations and offers high speed with low latency, making it particularly suitable for network-based applications.

ChaCha20-Poly1305 is a combination of the ChaCha20 stream cipher and the Poly1305 authentication function. ChaCha20 is a secure and robust stream cipher that is resistant to known attacks. Poly1305 provides strong authentication to ensure data integrity. ChaCha20-Poly1305 performs well on various platforms, including those without hardware acceleration for AES. This makes it particularly useful for mobile and embedded systems. ChaCha20 is devised to be secure against timing attacks, as it does not use lookup tables that could lead to such attacks. The algorithm is easy to implement and offers flexibility in use, making it a good choice for a wide range of applications. Like GCM, ChaCha20-Poly1305 also offers authenticated encryption, which means that both confidentiality and integrity of the data are ensured.

In a further embodiment, the calculation of key k is performed jointly in a handshake between the client (C) and the server (S) using another protocol, such as OPC Unified Architecture OPCUA, Secure Shell SSH, Wireguard, Transport Layer Security TLS and/or Internet Protocol Security IPSec. The integration of key calculation into another protocol offers advantages in terms of security, efficiency and interoperability in many applications. All of the protocols mentioned offer strong authentication mechanisms that ensure that communication only takes place between authenticated parties. Integrating key calculation into the handshake process ensures that keys are exchanged securely and in a trustworthy manner between the communication partners. These protocols offer protection against man-in-the-middle attacks through the use of encryption and authentication during the handshake. Calculating all keys during the handshake also enables centralized management and reduces complexity by consolidating key generation and distribution into a single process. Simultaneous calculation and distribution of keys during the handshake minimizes latency that could otherwise arise from separate key distribution mechanisms. The integration of key calculation into existing handshake protocols makes efficient use of already established communication channels and resources. OPCUA, SSH, Wireguard, TLS and IPSec are widely used standards that are employed in many industrial and IT systems. The use of these protocols ensures that the solution is interoperable and compatible with existing systems. The use of standardized protocols ensures that the implementation is consistent and easy to integrate. The integration of key calculation into the handshake allows for flexible scaling of the solution, as it can be easily adapted to different network sizes and topologies. The solution can be easily extended by using additional security mechanisms within the protocols to meet future security requirements. The use of established and proven protocols such as OPCUA, SSH, Wireguard, TLS and IPSec increases the reliability of the system and provides robust error handling mechanisms. By integrating them into the handshake process, the keys are only generated and distributed upon successful authentication and handshake, making the system more resistant to attacks.

In a technically advantageous embodiment, the proxy server (P) receives the exchanged handshake messages from both the client (C) and the server (S) and forwards them to the other party.

In a technically advantageous embodiment, the method comprises the following additional step:
Calculating the random string Rᵢ by the proxy server (P) using a pseudo-random function (PRF) or a pseudo-random number generator (PRG).

Using a proxy server to calculate a random string Rᵢ using a pseudo-random function (PRF) offers several advantages, particularly in cryptographic and security-related applications. An important advantage here, per an embodiment, is high unpredictability: PRFs are devised so that their outputs, based on a secret input value (seed), are difficult to predict. This is crucial for security in cryptographic applications, where predictability of random values could lead to security vulnerabilities. Consistency and repeatability: Unlike true random sources, which generate different values each time they are called, PRFs can always produce the same results when using the same seed and input value. This is useful for scenarios that require repeatability, such as test environments. Further advantages can lie in particular in the efficiency of using PRFs. PRFs are algorithmically efficient and can be calculated quickly, making them ideal for applications that require fast generation of random values. The low resource consumption of PRFs is also advantageous. PRFs require fewer resources than some true random number generators, which may rely on special hardware or external physical sources. Since PRFs are deterministic, the same input can always produce the same output. This can be particularly useful for debugging and log verification, as it ensures that the same sequence of operations always produces the same results. A proxy server can centrally generate many random values for different clients or applications, which simplifies the management and distribution of random values. The proxy server can efficiently scale and distribute the generation of random values to handle high loads or many simultaneous requests. PRFs can be used for a variety of cryptographic applications, including key generation, one-time pads, initialization vectors for encryption, and much more. The seed or input value can be easily changed to generate different random values, allowing for flexibility in use. PRFs are based on well-established cryptographic principles and offer strong security guarantees as long as the seed is kept secret. They are less susceptible to environmental factors or manipulations that could affect physical random number generators. A PRF-based system implemented as described above is resistant to a variety of attacks, including prediction attacks and replay attacks.

In a technically advantageous embodiment, the secret shares of the received data are processed and the data to be sent

$${M}_{j}^{′}$$

is calculated by applying a cryptographic secure multi-party computation (MPC) method. Multi-party computation (MPC), also known as secure multi-party computation, is a field of cryptography that allows multiple parties to jointly perform a computation without any party knowing the private inputs of the other parties. The goal of MPC is to preserve the confidentiality of individual inputs while ensuring the correct result of the computation. By using secret sharing and MPC, the individual parties do not have to disclose their data. The data remains encrypted and secure throughout the process, minimizing the risk of data leaks or unauthorized access. MPC enables multiple parties to perform calculations without any one party having control or access to the entire data set. This protects against insider attacks and ensures that malicious actors cannot compromise the data. The use of MPC ensures that all calculations are performed correctly and in a manner secure against manipulation. No participant can alter the results of the calculations without being detected. MPC protocols can be configured to deliver correct results even in the event of failure or misconduct by individual participants. This increases the robustness and reliability of the system. MPC eliminates the need for a central trusted authority to process the data. This reduces single points of failure and increases the system's resilience to attacks. The calculations are distributed across multiple participants, which spreads the load evenly and improves the scalability of the system. MPC protocols can be easily scaled to handle more participants or larger amounts of data. This makes them flexible and adaptable to different application requirements. Therefore, MPC can be adapted for a variety of cryptographic applications and scenarios, including secure cloud computing, private data analysis, and collaborative decision-making. At the same time, the servers can apply secure multi-party computation (MPC) methods to the secret sharings in order to perform any calculations on the data, such as filtering, calculating statistics, data analysis, or evaluating AI models.

In a technically advantageous embodiment, the method comprises the following additional step:
Performing pre-calculations using the proxy server and the server before receiving the client's data.

Even before receiving the message from the client, the proxy server and the server can perform pre-calculations, which allow the MPC method to be carried out more efficiently. In particular, in an advantageous embodiment, the step of performing pre-calculations using the proxy server and the server before receiving the data of the client may comprise the following additional steps:
Performing pre-calculations of the random string R by the proxy server (P) and its share of the response

$${M}_{j}^{′}$$

even before receiving the message,
Pre-calculating a garbled circuit based on this,
Sending the garbled circuit to the server, wherein as soon as the data is received from the client, the server uses oblivious transfer (OT) to select the labels that match its share and evaluates the garbled circuit to obtain its share of the response

$${M}_{j}^{′} ,$$

Sending the share in encrypted form to the proxy server.

Garbled Circuits is a specific technique within secure multi-party computation that was introduced by Andrew Yao in the 1980s. It enables two parties to perform a joint computation without revealing their inputs. The functioning of garbled circuits can be summarised as follows:
Circuit generation: The function to be calculated is represented as a logical circuit (consisting of gates such as AND, OR, XOR).
Circuit obfuscation (garbling): The “garbler” (one party) garbles the circuit by generating random keys for each possible input and output of the gates and encrypting the truth tables of the gates.
Input encoding: The garbler encrypts its inputs with the corresponding keys and sends the garbled circuit and the encrypted inputs to the evaluator (the other party).
Circuit evaluation: The evaluator uses its own encrypted inputs and the garbled circuit to perform the calculation. In doing so, it decrypts the truth tables of the gates with the appropriate keys and finally obtains the encrypted result.
Result decryption: The evaluator decrypts the result to obtain the final result of the calculation.

The advantages of using garbled circuits, per various embodiments, are, firstly, security, as they enable secure calculations in which no party knows the other's inputs; flexibility, as they can be used for the secure calculation of any function; and confidentiality, as sensitive information is protected during the calculation. Oblivious transfer (OT) is a cryptographic protocol that allows a sender to transfer one or more messages to a recipient without the sender knowing which message(s) the recipient has received. This protocol plays a central role in secure multi-party computation (MPC) and other cryptographic applications, as it ensures confidentiality and data protection. In the context of garbled circuits, particularly in secure multi-party computation, “label selection” refers to the process by which the recipient obtains the correct encrypted values (labels) for their inputs. These labels are encrypted representations of the input values used in a garbled circuit.

In one embodiment, the proxy server (P) is located on the client side instead of on the server side. The proxy and the client act in the same way as the server and the proxy previously acted. This alternative is also applicable in conjunction with the original form of the invention, so that such a proxy server is located on both the client side and the server side.

An embodiment also specifies a system for data processing, comprising means for executing the steps of the method described above.

Furthermore, an embodiment specifies a computer program product, comprising instructions that cause the system described above to execute the steps of the method described above.

Further scope of applicability of the present disclosure will become apparent from the detailed description given hereinafter. But it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given below and the accompanying drawings, which are given by way of illustration only, and do not limit the present disclosure, and wherein:

FIG. 1 shows a block diagram of a system for standard-compliant, confidential receipt of data according to an embodiment, and

FIG. 2 shows a flowchart of a method for standard-compliant, confidential receipt of data according to an embodiment.

### DETAILED DESCRIPTION

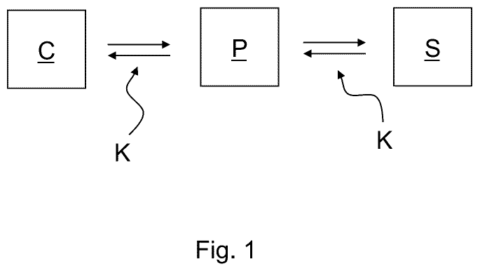

FIG. 1 shows a block diagram of a system for standard-compliant, confidential receipt of data according to an embodiment. The system is, in particular, a system for data processing and comprises a number of components that are configured to work together in a coordinated manner to collect, process, store and output data. The components of this system consist of at least one processor, which is used to perform calculations and control other system components, and a memory, which is used for the temporary and permanent storage of data and programs.

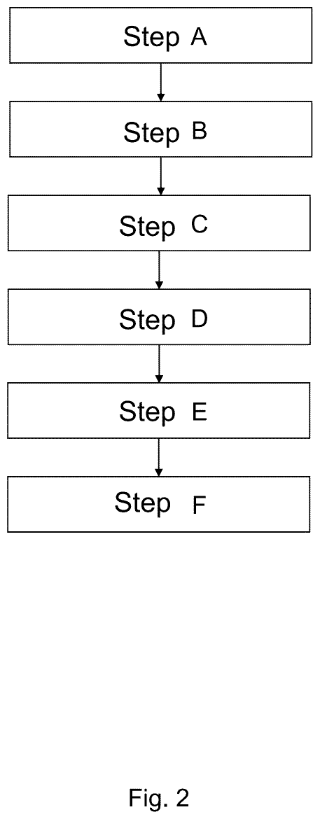

As shown in FIG. 1, the system comprises a server S, which in one embodiment may be embodied, for example, as a TLS server that implements the TLS standard (for example TLS 1.3, RFC 8446) and receives data from clients. Furthermore, the system comprises a client C which, in one embodiment, also implements the TLS standard and is set up to send data to the server S using a symmetric encryption method, which is described in more detail in the flowchart in FIG. 2. In addition, the system comprises at least one proxy server P, which is located on the communication path between C and S. All communication between the client C and the server S runs via the proxy server P. Basically, the method now divides a single server S, which receives the confidential data, into at least two servers P and S, so that P and S each receive a cryptographic secret sharing of the received data. Secret sharing guarantees that no single server receives information about the data received; from the perspective of each individual server, the data is purely random. At the same time, however, the servers can apply modern secure multi-party computation (MPC) methods to the secret sharings in order to perform any calculations on the data, such as filtering, calculating statistics, data analysis, or evaluating AI models.

The method is now described in more detail using the flowchart shown in FIG. 2 in accordance with an embodiment. The method is a computer-implemented method using a system for data processing comprising at least one client C, one server S and one proxy server P. The client C is set up to send data, wherein the server S has implemented a cryptographic protocol for encrypting data and is set up to receive data from the client C. The proxy server P is located on a communication path K between the client C and the server S, wherein any communication between the client C and the server S runs at least partially or completely via the proxy server P.

The method comprises the steps indicated in FIG. 2. In step A, data for calculating a shared key k is exchanged between the client C and the server S. In an embodiment, there are various methods by which the symmetric key k can be securely exchanged between the computers C and S. One possibility is for the key to be entered manually by a trusted person on both computers, which requires that the person keep and transfer the key securely. Another method is to exchange the key via encrypted email, wherein both parties must already have secure email encryption such as PGP or S/MIME. Similarly, the key can be stored in an encrypted file archive, for example using Zip with AES encryption, in a cloud storage service so that both parties can download and decrypt the key. In addition, secure file exchange services such as SecureDrop or OnionShare, which operate via the Tor network, can be used to transfer the key securely. Another option is to transmit the key in parts via a secure phone call, with one part of the key being transmitted via a call and the other part via another secure method to increase security. The key can also be converted into a QR code and then exchanged between the parties using a secure, physically scanned medium. Alternatively, the key can be loaded onto a smart card or hardware security module (HSM), which is then physically transported to the systems involved and used there. Transfer via NFC (Near Field Communication) or Bluetooth is also possible, provided that both devices are in close proximity and the transfer is encrypted. Another option is to exchange the key via a secure transport protocol such as TLS or IPSec, wherein a secure connection is first established and the key is then transferred via this connection. Instead of directly exchanging the key k, both parties can derive the key k from a shared secret and additional parameters, such as nonces. A public key infrastructure (PKI) can also be used, whereby one party encrypts the symmetric key with the other party's public key and sends it, so that the recipient can decrypt the key with their private key. If, for example, the cryptographic protocol is a Transport Layer Security TLS encryption protocol, a communication session can be started between the client C and the server S using a TLS handshake. Since TLS uses message authentication codes (MACs), the server S derives a MAC key k_{MAC} from the key k and makes it available to P. The cryptographic protocol may comprise at least one of the following protocols: OPC Unified Architecture OPCUA, Secure Shell (SSH), Wireguard, Transport Layer Security (TLS) and/or Internet Protocol Security (IPSec). All protocols (OPCUA, SSH, Wireguard, TLS and IPSec) have in common that communication can be roughly divided into two phases: A key exchange phase and a communication phase. The method can be applied equally to each of these protocols. During the key exchange phase, the proxy only forwards the communication and only becomes active during the communication phase.

In step B, data is sent from client C to server S, wherein the data is encrypted using an operating mode in which block ciphers are operated for a symmetric encryption application, wherein the i-th message from client C to server S consists of an encryption Mᵢ⊕Kᵢ. Here, Mᵢ is the plain-text data of the i-th message and Kᵢ is the key of the operating mode, which is derived from k and the value tᵢ is the cryptographic value of the message. In one embodiment, the operating mode may comprise a counter mode CTR, a Galois counter mode GCM and/or a ChaCha20-Poly1305 method.

In step C, the data is received by the proxy server P and the value tᵢ is processed in accordance with the cryptographic protocol, wherein tᵢ is the cryptographic value of the message. If the cryptographic protocol is a Transport Layer Security TLS encryption protocol, the value tᵢ is processed in accordance with the TLS standard.

In step D, the proxy server P selects a random string Rᵢ, wherein the length of the random string Rᵢ corresponds to the length of Mᵢ⊕Kᵢ.

In step E, Mᵢ⊕Kᵢ⊕Rᵢ is forwarded to the server S by the proxy server P and the random string Rᵢ is stored by the proxy server P.

In step F, Mᵢ⊕Kᵢ⊕Rᵢ is received by the server S and value Mᵢ⊕Rᵢ is calculated using the key Kᵢ, wherein Rᵢ⊕(Mᵢ⊕Rᵢ)=Mᵢ applies, whereby the proxy server P and the server S each obtain an additive ⊕ secret sharing of the data Mᵢ. The message authentication codes (MACS) additionally calculated in Galois Counter Mode, for example, can be checked by applying a cryptographic secure multi-party computation (MPC) method.

Sending a message

$${M}_{j}^{′}$$

comprises the following step. First, in a first step, the encryption of the secret share

$$( {R}_{j}^{′} ⊕ {M}_{j}^{′} )$$

⊕Kⱼ is calculated by the server S, wherein Kᵢ is derived from k_{Enc} and

$$( {R}_{j}^{′} ⊕ {M}_{j}^{′} )$$

is the secret share of

$${M}_{j}^{′}$$

held by the server. The encryption is then sent to the proxy server P via the server S and a cipher text

$${M}_{j}^{′} ⊕ {K}_{j}$$

is calculated by the proxy server P using a share

$${R}_{j}^{′}$$

and a valid MAC using k_{MAC} by the proxy server P. In addition,
the proxy server P can apply the key k_{MAC} to calculate the required MAC according to the TLS standard and thus obtain the cipher text to be sent to the client. In one embodiment, the secret shares of the received data are processed and the data to be sent

$${M}_{j}^{′}$$

is calculated by applying a cryptographic secure multi-party computation (MPC) method.

As described, confidential emails are only one of many examples of applications in which the method according to an embodiment can be used. Other areas of application for the method are, for example:

Reliable benchmarking: Various companies supply confidential key data to a central service provider. This processes the key data confidentially and uses it to calculate statistics that enable participating companies to perform reliable benchmarking. This benchmarking allows the identification of potential for efficiency gains or cost savings.

Confidential machine data: Various operators of production machines collect machine data. This data is confidential because it allows conclusions to be drawn about production processes and thus trade secrets. This data is transmitted to a central service provider, who processes it confidentially. This data is used, for example, to predict maintenance requirements (predictive maintenance), identify potential for optimisation in machine operation, or collect and compare key performance indicators such as downtime and maintenance intensity in order to identify potential for improvement.

Medical data: Confidential medical patient data is highly sensitive and should therefore be stored in encrypted form throughout (i.e. end-to-end). At the same time, it would be helpful for medical research and the development of therapies, detection of side effects, etc., to be able to carry out evaluations on a large number of people. This could be achieved by storing the data jointly at a shared service provider.

Data spaces and data trustees: In the course of digitalization, data spaces and data trustees are being discussed and implemented. One example of this is the Mobility Data Space (https://bmdv.bund.de/DE/Themen/Digitales/Mobility-Data-Space/mds.html). The idea behind shared data spaces is to give data to a data trustee for joint processing, who can then process it centrally.

Secure file storage with server-side functionality: Secure file storage in cloud storage can be achieved, for example, by encryption with special tools. However, encryption makes it impossible for the cloud provider to enable server-side functions such as search or filter functions, automatic document classification, spell checking, processing with large language models such as ChatGPT, or access via a web interface. These functions can only be achieved with unencrypted file storage.

All features described in conjunction with individual embodiments of the invention may be provided in different combinations in the subject matter according to the invention in order to simultaneously realize their advantageous effects, even if they have been described in different embodiments.

The scope of protection of the present invention is given by the claims and is not limited by the features explained in the description or shown in the figures.

As used herein, the terms “general,” “generally,” “approximately,” and “substantially” are intended to account for the inherent degree of variance and imprecision that is often attributed to, and often accompanies, any design and manufacturing process and measurement, including engineering tolerances, and without deviation from the relevant functionality and intended outcome, such that mathematical precision and exactitude is not implied and, in some instances, is not strictly possible. In other instances, the terms “general,” “generally,” “approximately,” and “substantially” are intended to represent the inherent degree of uncertainty that is often attributed to any quantitative comparison, value, and measurement calculation, or other representation, such that mathematical precision and exactitude is not implied and, in some instances, is not strictly possible.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

Those of skill in the art will understand that modifications (additions and/or removals) of various components of the substances, formulations, apparatuses, methods, systems, and embodiments described herein may be made without departing from the full scope and spirit of the present disclosure, which encompass such modifications and any and all equivalents thereof.

### LIST OF REFERENCE SIGNS

Server S
Client C
Proxy server P; P₁, . . . , Pₙ
Data M
Communication path K

1. A computer-implemented method for standard-compliant, confidential receipt of data, wherein the method is executable via a system for data processing, in particular a system for standard-compliant, confidential receipt of data, the system comprising:
at least one client, wherein the client is set up to send data,
at least one server, wherein the server has implemented a cryptographic protocol for encrypting data and is set up to receive data from the client,
at least one proxy server located on a communication path between the client and the server, wherein communication between the client and the server runs partially or completely via the proxy server,
the method comprising the following steps:
A. exchanging data for calculating a shared key k between the client and the server, wherein the server derives at least one key k_{Enc} from the key k, wherein k_{Enc} is identical to k or is calculated from k, using a key derivation function or a hash function,
B. sending data from the client to the server, wherein the data is encrypted using an operating mode in which block ciphers are operated for a symmetric encryption application, wherein the i-th message tᵢ from the client to the server contains an encryption Mᵢ⊕Kᵢ, wherein Mᵢ is the plain-text data of the i-th message and Kᵢ is the key of the operating mode, which is derived from k_{Enc} and the value tᵢ is the cryptographic value of the message,
C. receiving the data by the proxy server and processing the value tᵢ in accordance with the cryptographic protocol, wherein tᵢ is the cryptographic value of the message,
D. selecting a random string Rᵢ by the proxy server, wherein the length of the random string Rᵢ corresponds to the length of Mᵢ⊕Kᵢ,
E. forwarding Mᵢ⊕Kᵢ⊕Rᵢ to the server through the proxy server and storing the random string Rᵢ by the proxy server,
F. receiving Mᵢ⊕Kᵢ⊕Rᵢ by the server and calculating the value Mᵢ⊕Rᵢ using the key Kᵢ, wherein Rᵢ⊕(Mᵢ⊕Rᵢ)=Mᵢ applies, whereby the proxy server and the server each obtain an additive ⊕ secret sharing of the data Mᵢ,
wherein the method for sending a message
$${M}_{j}^{′}$$
comprises the following steps:
G. calculating an encryption of a secret share
$$( {R}_{j}^{′} ⊕ {M}_{j}^{′} )$$
⊕Kⱼ via the server, wherein Kⱼ is derived from k_{Enc} and
$$( {R}_{j}^{′} ⊕ {M}_{j}^{′} )$$
is the secret share of
$${M}_{j}^{′}$$
held by the server,
H. sending the encryption to the proxy server via the server, calculating a cipher text
$${M}_{j}^{′} ⊕ {K}_{j}$$
via the proxy server by applying a share
$${R}_{j}^{′} .$$

2. The method according to claim 1, wherein the proxy server sends only the length of the value Mᵢ⊕Kᵢ to the server, wherein the proxy server uses Mᵢ⊕Kᵢ as its secret share and the server uses Kᵢ as its secret share.

3. The method according to claim 1, wherein the exchange of data for calculating a shared key k between the client and the server comprises starting a communication session between the client and the server, wherein the cryptographic protocol for exchanging k comprises at least one of the following protocols: OPC Unified Architecture OPCUA, Secure Shell SSH, Wireguard, Transport Layer Security TLS and/or Internet Protocol Security IPSec.

4. The method according to claim 1, wherein the method comprises a cryptographic message authentication code MAC to achieve authenticity and integrity, wherein the cryptographic key k_{MAC} is a MAC key and the server derives the MAC key k_{MAC} from the key k and makes it available to the proxy server.

5. The method according to claim 4, wherein the calculation and verification of the MAC is performed using secure multi-party computation and the key k_{MAC} is not made available to the proxy server.

6. The method according to claim 4, wherein the proxy server uses the key k_{MAC} to calculate the required message authentication code MAC according to at least one of the following protocols: OPC Unified Architecture OPCUA, Secure Shell SSH, Wireguard, Transport Layer Security TLS and/or Internet Protocol Security IPSec, in order to obtain the cipher text to be sent to the client.

7. The method according to claim 1, wherein the operating mode comprises a counter mode CTR, a Galois counter mode GCM and/or a ChaCha20-Poly1305 method.

8. The method according to claim 1, wherein the calculation of key k is performed jointly in a handshake between the client and the server using at least one of the following protocols: OPC Unified Architecture OPC UA, Secure Shell SSH, Wireguard, Transport Layer Security TLS and/or Internet Protocol Security IPSec.

9. The method according to claim 8, wherein the proxy server receives the exchanged handshake messages from both the client and the server and forwards them to the other party.

10. The method according to claim 1, wherein the method comprises the following additional step:
calculating the random string Rᵢ by the proxy server using a pseudo-random function PRF or a pseudo-random number generator PRG.

11. The method according to claim 1, wherein the secret shares of the received data are processed and the data to be sent
$${M}_{j}^{′}$$
is calculated by applying a cryptographic secure multi-party computation MPC method.

12. The method according to claim 1, wherein the method comprises the following additional step:
performing pre-calculations using the proxy server and the server before receiving the data of the client.

13. The method according to claim 12, wherein the step of performing pre-calculations using the proxy server and the server before receiving the data of the client comprises the following additional steps:
performing pre-calculations of the random string Rᵢ by the proxy server and its share of the response
$${M}_{j}^{′}$$
even before receiving the message,
pre-calculating a garbled circuit based on this,
sending the garbled circuit to the server, wherein as soon as the data is received from the client, the server uses oblivious transfer to select the labels that match its share and evaluates the garbled circuit to obtain its share of the response
$${M}_{j}^{′} ,$$
sending the share in encrypted form to the proxy server.

14. The method according to claim 1, wherein the proxy server is located on the client side instead of on the server side.

15. A system for data processing, comprising means for executing the steps of the method according to claim 1.

16. A computer program product, comprising instructions that cause the system according to claim 15.
